(19) United States
(12) Patent Application Publication
(10) Pub. No.: US 2019/0294735 A1
(43) Pub. Date: Sep. 26, 2019

(54) SEARCH FUNCTIONS FOR SPREADSHEETS

(71) Applicant: Apple Inc., Cupertino, CA (US)

(72) Inventors: Edward P. Hogan, Pittsburgh, PA (US); Jonathan R. Speicher, Pittsburgh, PA (US); Matthew R. Lehrian, Pittsburgh, PA (US); Shawn P. Flisakowski, Saratoga, CA (US)

(21) Appl. No.: 15/935,964

(22) Filed: Mar. 26, 2018

(51) Int. Cl. G06F 17/30; G06F 17/27

(52) U.S. Cl. CPC G06F 17/30985; G06F 17/30991; G06F 17/3056; G06F 17/2765

(57) ABSTRACT

Embodiments are disclosed in which a process receives, via a graphical user interface (GUI) of a spreadsheet application, a function call. The function call includes a source string attribute identifying a string and a search string attribute identifying a substring to be identified in the string. The process performs a function associated with the function call by searching for the substring in the string and subsequently returning a subset of the string proximate to a location of the substring in the string.

### BACKGROUND

The present disclosure relates generally to searching portions of spreadsheets via evaluation statements (i.e., functions), such as a table within a spreadsheet application.

Spreadsheet applications, as well as other types of applications, may use rows and columns of cells (such as arrays or tables of such cells) in which a user enters or manipulates data for calculation or presentation. Tables of cells used in such applications may range from a limited number of cells in simple or straightforward implementations to much larger arrays of cells in more complex scenarios. The tables may be used to relay and organize data to a user for various scenarios. Often an application may allow a user to define an evaluation statement (i.e., a function) within a cell that provides a calculation to perform and/or references other cells within the spreadsheet. Oftentimes, a user may be interested in retrieving only a portion (e.g., a subset) of the data that a particular cell contains. As such, it may be beneficial for a user to search, via a function, a certain portion of data from within a cell to enhance conventional spreadsheet searching capabilities.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

### BRIEF DESCRIPTION OF THE DRAWINGS

Various aspects of this disclosure may be better understood upon reading the following detailed description and upon reference to the drawings in which:

FIG. 1 is a block diagram of an electronic device that may use the techniques disclosed herein, in accordance with aspects of the present disclosure;

FIG. 2 is a front view of a handheld device, such as an iPhone® by Apple Inc., representing an example of the electronic device of FIG. 1;

FIG. 3 is a front view of a tablet device, such as an iPad® by Apple Inc., representing an example of the electronic device of FIG. 1;

FIG. 4 is a perspective view of a notebook computer, such as a MacBook Pro® by Apple Inc., representing an example of the electronic device of FIG. 1;

FIG. 5 illustrates an example of a graphical user interface (GUI) interface screen of a spreadsheet application in accordance with aspects of the present disclosure;

FIG. 6 depicts a process flow diagram depicting control logic of a process for enhanced searching capabilities in a spreadsheet application, in accordance with aspects of the present disclosure;

FIG. 7 depicts a process flow diagram depicting control logic of the identification of a function type step of the process of FIG. 6, in accordance with aspects of the present disclosure;

FIG. 8A-8C illustrate examples of portions of the spreadsheet application GUI interface screens illustrating evaluation statements evaluated in the spreadsheet application in accordance with aspects of the present disclosure;

FIG. 9 illustrates an example of the spreadsheet application GUI interface screen illustrating an evaluation statement evaluated in the spreadsheet application in accordance with aspects of the present disclosure;

FIG. 10 illustrates an example of the spreadsheet application GUI interface screen illustrating an evaluation statement evaluated in the spreadsheet application that results in an error message being displayed in accordance with aspects of the present disclosure;

FIG. 11 illustrates an example of the spreadsheet application GUI interface screen illustrating a wild card search feature used in an evaluation statement that is evaluated in the spreadsheet application in accordance with aspects of the present disclosure;

FIG. 12 illustrates an example of a portion of the spreadsheet application GUI interface screen for performing a TEXTBETWEEN function in the spreadsheet application in accordance with aspects of the present disclosure;

FIG. 13A illustrates an example of a portion of the spreadsheet application GUI interface screen illustrating an evaluation statement evaluating non-text data in the spreadsheet application in accordance with aspects of the present disclosure;

FIG. 13B illustrates an example of a portion of the spreadsheet application GUI interface screen illustrating an evaluation statement for evaluating non-text data in the spreadsheet application in accordance with aspects of the present disclosure;

FIG. 14 illustrates a process for converting a value of a source string attribute to a string value in accordance with aspects of the present disclosure;

FIG. 15 illustrates a process for converting a value of a search string attribute to a string value in accordance with aspects of the present disclosure; and

FIG. 16 illustrates a process for maintaining a dependency tree of the evaluation statements in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

The present disclosure is generally directed to enhancing spreadsheet searching capabilities within a table when it is desired to search for and extract a portion of contents of a reference cell and/or a source string. In practice, retrieving a portion (i.e., a search string attribute) of the contents of a referenced cell (i.e., a sub-portion) may be accomplished by various functions, including but not limited to TEXTBETWEEN, TEXTBEFORE, and TEXTAFTER and one or more attributes (e.g., search string(s)) that indicate a context for the portion. Each of the functions may include one or more attribute values to carry out the function. Some of the evaluation statements may include function calls that may require the user to specify one source string attribute and one search string attribute. Examples of evaluation statements in which one source string attribute and one search string attribute are specified include the TEXTBEFORE and TEXTAFTER functions, as explained further below. Other evaluation statements may require the user to specify one source string attribute and more than one search string attribute. For example, the TEXTBETWEEN function may include a search prefix and a search suffix to identify a location in the search string where the search should be performed. In practice, a source string attribute and a search string attribute (that identifies a substring within the source string) are identified prior to the search function being executed. Once the source string and search string(s) are identified, the substring (identified by the search string) within the source string is identified (e.g., in accordance with a function type of the evaluation statement) and is returned as a resultant value for the expression statement.

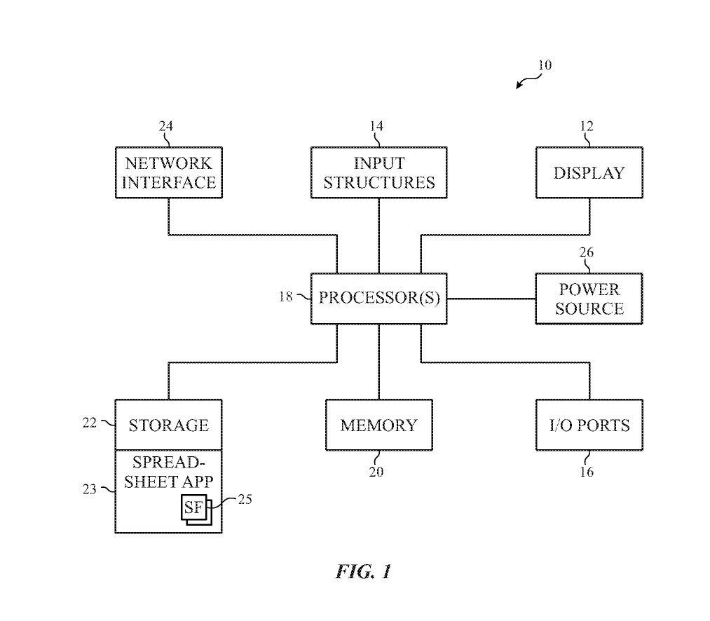

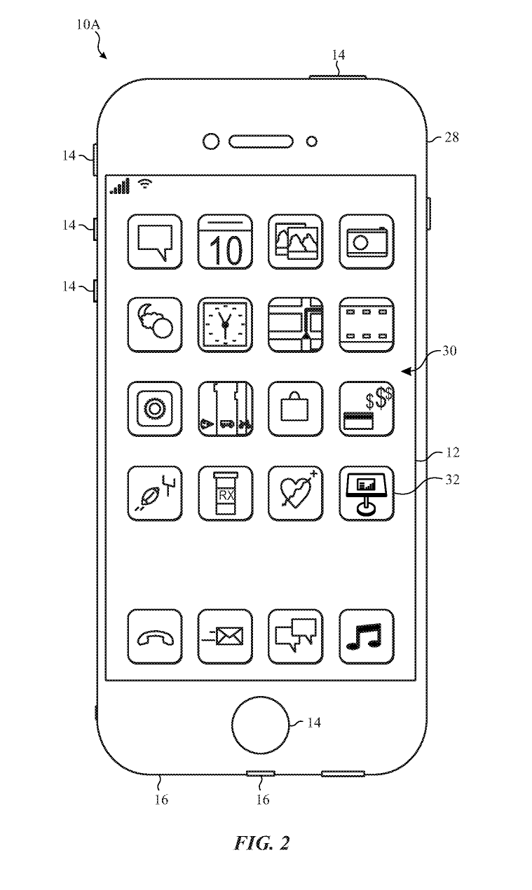

A variety of suitable electronic devices may employ the techniques described herein when executing or interacting with a spreadsheet application or other application employing cells or tables of such cells. FIG. 1, for example, is a block diagram depicting various components that may be present in a suitable electronic device 10 that may be used in the implementation of the present approaches. FIGS. 2, 3, and 4 illustrate example embodiments of the electronic device 10, depicting a handheld electronic device, a tablet computing device, and a notebook computer, respectively.

Turning first to FIG. 1, the electronic device 10 may include, among other things, a display 12, input structures 14, input/output (I/O) ports 16, one or more processor(s) 18, memory 20, nonvolatile storage 22 that may store a spreadsheet application 23 that contains various search functions 25, a network interface 24, and a power source 26. The various functional blocks shown in FIG. 1 may include hardware elements (including circuitry), software elements (including computer code stored on a non-transitory computer-readable medium) or a combination of both hardware and software elements. The search functions 25 may provide enhanced searching capabilities when executed by an application of the electronic device 10. For example, an expression statement may be executed via an application (e.g., a spreadsheet application) running on the processor(s) 18 of the electronic device 10. The evaluation statement may include a function call for one of the search functions 25 (e.g., a text search function call) that retrieves information (e.g., portions of a search string within a source string). The application may provide a result for the evaluation statement (e.g., the searched portion of the source string). As will be discussed in more detail below, the processor(s) 18 may perform certain pre-processing steps prior to executing a function call. For example, a value associated with a search string attribute and/or a source string attribute may be converted to a string value when it is determined that the search string attribute or the source string attribute is not a string value. The techniques described herein are described in detail below.

It should be noted that FIG. 1 is merely one example of a particular implementation and is intended to illustrate the types of components that may be present in the electronic device 10. Indeed, the various depicted components (e.g., the processor(s) 18) may be separate components, components of a single contained module (e.g., a system-on-a-chip device), or may be incorporated wholly or partially within any of the other elements within the electronic device 10. The components depicted in FIG. 1 may be embodied wholly or in part as machine-readable instructions (e.g., software or firmware), hardware, or any combination thereof.

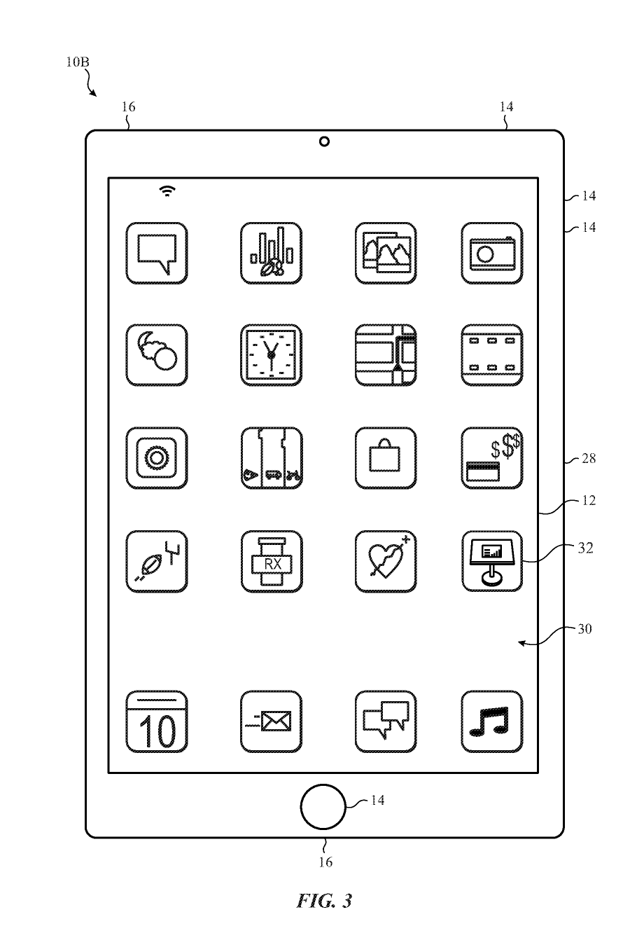

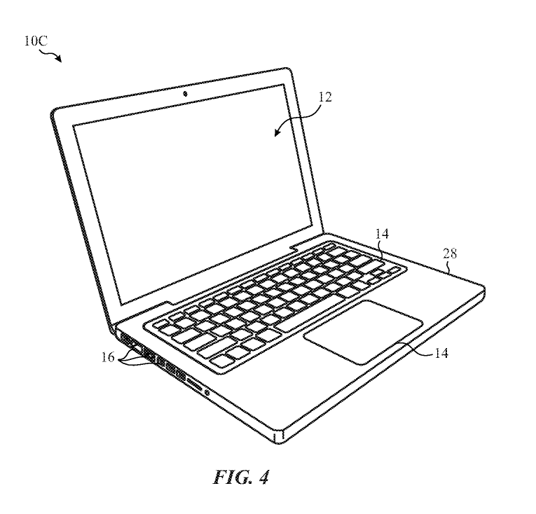

By way of example, the electronic device 10 may represent a block diagram of the handheld device depicted in FIG. 2, the tablet computing device depicted in FIG. 3, the notebook computer depicted in FIG. 4, or similar devices, such as desktop computers, televisions, and so forth. In the electronic device 10 of FIG. 1, the display 12 may be any suitable electronic display used to display image data (e.g., a liquid crystal display (LCD) or an organic light emitting diode (OLED) display). In some examples, the display 12 may represent one of the input structures 14, enabling users to interact with a user interface of the electronic device 10. In some embodiments, the electronic display 12 may be a MultiTouch™ display that can detect multiple touches at once. Other input structures 14 of the electronic device 10 may include buttons, keyboards, mice, trackpads, and the like. The I/O ports 16 may enable electronic device 10 to interface with various other electronic devices.

The processor(s) 18 and/or other data processing circuitry may execute instructions and/or operate on data stored in the memory 20 and/or nonvolatile storage 22. The memory 20 and the nonvolatile storage 22 may be any suitable articles of manufacture that include tangible, non-transitory computer-readable media to store the instructions or data, such as random-access memory, read-only memory, rewritable flash memory, hard drives, and optical discs. By way of example, a computer program product containing the instructions may include an operating system (e.g., OS X® or iOS by Apple Inc.) or an application program (e.g., Numbers® by Apple Inc.).

The network interface 24 may include, for example, one or more interfaces for a personal area network (PAN), such as a Bluetooth network, for a local area network (LAN), such as an 802.11x Wi-Fi network, and/or for a wide area network (WAN), such as a 4G or LTE cellular network. The power source 26 of the electronic device 10 may be any suitable source of energy, such as a rechargeable lithium polymer (Li-poly) battery and/or an alternating current (AC) power converter.

As mentioned above, the electronic device 10 may take the form of a computer or other type of electronic device. Such computers may include computers that are generally portable (such as laptop, notebook, and tablet computers) as well as computers that are generally used in one place (such as conventional desktop computers, workstations and/or servers). FIG. 2 depicts a front view of a handheld device 10A, which represents one embodiment of the electronic device 10. The handheld device 10A may represent, for example, a portable phone, a media player, a personal data organizer, a handheld game platform, or any combination of such devices. By way of example, the handheld device 10A may be a model of an iPod® or iPhone® available from Apple Inc. of Cupertino, Calif.

The handheld device 10A may include an enclosure 28 to protect interior components from physical damage and to shield them from electromagnetic interference. The enclosure 28 may surround the display 12, which may display a graphical user interface (GUI) 30 having an array of icons 32. By way of example, one of the icons 32 may launch a spreadsheet application program (e.g., Numbers® by Apple Inc.). User input structures 14, in combination with the display 12, may allow a user to control the handheld device 10A. For example, the input structures 14 may activate or deactivate the handheld device 10A, navigate a user interface to a home screen, navigate a user interface to a user-configurable application screen, activate a voice-recognition feature, provide volume control, and toggle between vibrate and ring modes. Touchscreen features of the display 12 of the handheld device 10A may provide a simplified approach to controlling the spreadsheet application program. The handheld device 10A may include I/O ports 16 that open through the enclosure 28. These I/O ports 16 may include, for example, an audio jack and/or a Lightning® port from Apple Inc. to connect to external devices. The electronic device 10 may also be a tablet device 10B, as illustrated in FIG. 3. For example, the tablet device 10B may be a model of an iPad® available from Apple Inc.

In certain embodiments, the electronic device 10 may take the form of a computer, such as a model of a MacBook®, MacBook® Pro, MacBook Air®, iMac®, Mac® mini, or Mac Pro® available from Apple Inc. By way of example, the electronic device 10, taking the form of a notebook computer 10C, is illustrated in FIG. 4 in accordance with one embodiment of the present disclosure. The depicted computer 10C may include a display 12, input structures 14, I/O ports 16, and a housing 28. In one embodiment, the input structures 14 (e.g., a keyboard and/or touchpad) may be used to interact with the computer 10C, such as to start, control, or operate a GUI or applications (e.g., Numbers® by Apple Inc.) running on the computer 10C.

With the preceding in mind, a variety of computer program products, such as applications or operating systems, may use or implement the techniques discussed below to enhance the user experience on the electronic device 10 and to improve the performance of the device when executing an application encoded as discussed herein. Indeed, any suitable computer program product that provides for the use or manipulation of cells within a table or spreadsheet, including the referencing of other cells from a given cell, may employ and benefit from some or all of the techniques discussed below. For instance, the electronic device 10 may store and run a spreadsheet application 34 (e.g., Numbers® from Apple Inc.). The spreadsheet application may be stored as one or more executable routines (which may encode and implement the actions described below) in memory and/or storage (FIG. 1). These routines, when executed, may cause control codes and logic as discussed herein to be implemented and may cause screens as discussed herein to be displayed on a screen of the electronic device or in communication with the electronic device.

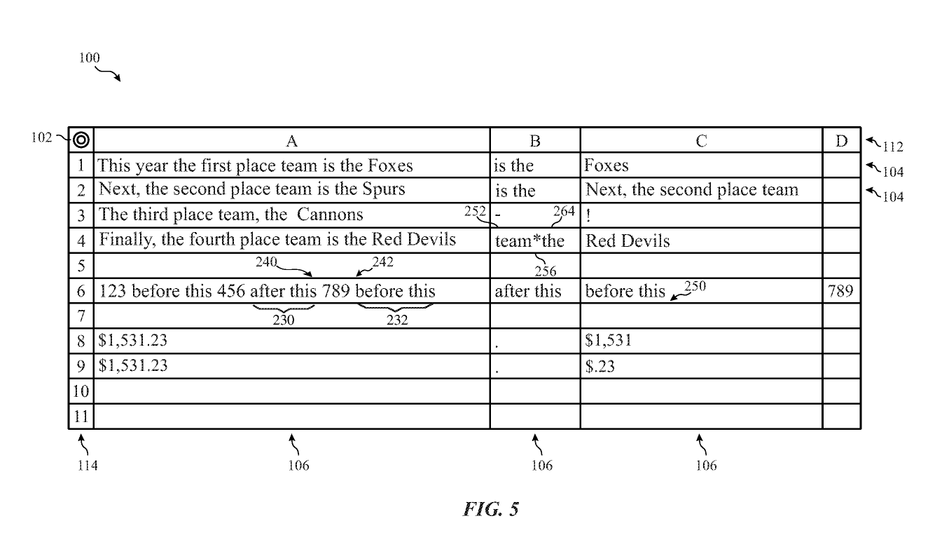

Turning to FIG. 5, an example of a spreadsheet application interface screen 100 is provided in accordance with aspects of the present disclosure. The spreadsheet application interface screen 100 includes a table 102 having rows 104 and columns 106 of cells. In the depicted example, the table 102 is of finite size (e.g., 11 rows×4 columns), not including the header row and header column. That is, the table 102 is not an “infinite” table composed of rows and columns of cells that fill the entire application display area in both horizontal and vertical dimensions. Such “infinite” table contexts provide an essentially limitless array of cells, though in such contexts there may in fact be a maximum number of rows and columns, this maximum number generally greatly exceeds any real world application or table size. Thus, in contrast to such “infinite” tables, the table 102 is of a limited, finite size and is handled as a table object provided by the application.

Upon selection of a cell within the table 102, a user may be provided a prompt or other entry box by which text, numbers, formula, and so forth may be entered as the contents of a cell or by which the existing contents of a cell may be edited or modified. In the depicted example, the uppermost row 112 and leftmost column 114 may be set aside or visually distinguished to allow this row and column to display row or column headings or labels. Further, row and column address indicators or indexes may also be displayed that may be automatically populated with an index of column addresses or headers (e.g., A, B, C, D, and so forth) or, respectively, with an index of row addresses or headers (e.g., 1, 2, 3, 4, and so forth). In this manner an addressing scheme may be provided for each cell within the table 102 such that individual cells may be identified by column and row address (e.g., A1, B3, D30, and so forth).

As discussed above, in certain instances a cell within a table 102 may contain an evaluation statement that includes a function call. The function call may call a function (e.g., search functions 25 of FIG. 1). In some situations, the the function call may reference other cells in the table 102 or in other table objects present on the canvas 108 or in other spreadsheets. The function calls might include calls to search text functions (including functions to return a starting position of one string within another, or functions to return a string where the specified characters of a given string have been replaced with a new string, etc.) and reference functions (such as functions to find a match for a given search value in one range, and return the value in the cell with the same relative position in a second range). Similarly, such evaluation statements may also include functions related to the layout or redirection of the contents of a cell for various display or calculation purposes.

In practice, a user may provide an instruction to the application to calculate or evaluate data via the evaluation statements. Certain evaluation statements may require the user to specify one or more one or more attribute values (e.g., a source string attribute and/or search string attributes, as discussed in more detail below) to carry out a function (e.g., TEXTBETWEEN, TEXTBEFORE, TEXTAFTER) associated with the evaluation statement.

As will be discussed in detail below, these functions may search for a text string within a source string and return a substring of the source string that is spatially situated in a manner desired by the function (e.g., before the search string for TEXTBEFORE, after the search string for TEXTAFTER, and/or between search strings for TEXTBETWEEN). The provided attribute functions may include a source string attribute and one or more search string attributes.

Source string attributes provide an indication of a text string to search within a spreadsheet. As may be appreciated, the source string attribute may include a cell reference (e.g., A2) or a string of text (e.g., “Next, the second place team is the Spurs”).

Search string attributes provide an indication of a string of text to search for within the source string. The search string attribute may include a cell reference (e.g., B2) or a string of text (e.g., “is the”). Certain functions (e.g., TEXTBETWEEN) may include more than one search string attribute. For example, the TEXTBETWEEN function may include a search prefix and a search suffix to identify a location in the source string where the text should be identified.

### Enhanced Spreadsheet Searching Capabilities

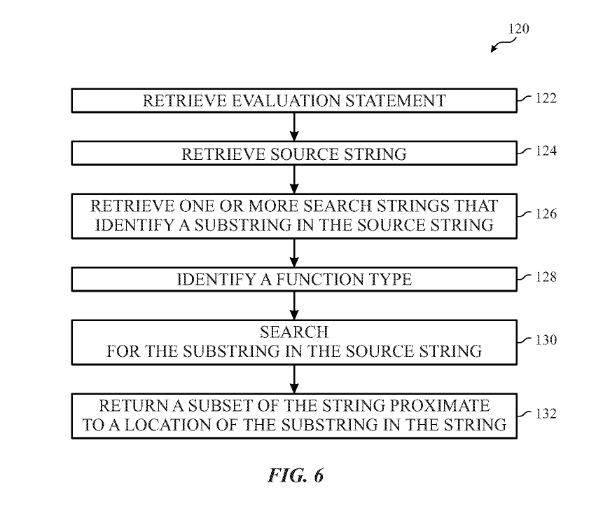

With the preceding in mind, and to facilitate explanation, FIG. 6 illustrates a process 120 for processing evaluation statements, in accordance with aspects of the present disclosure. The process 120 may be implemented via computer interpretable instructions of a spreadsheet application.

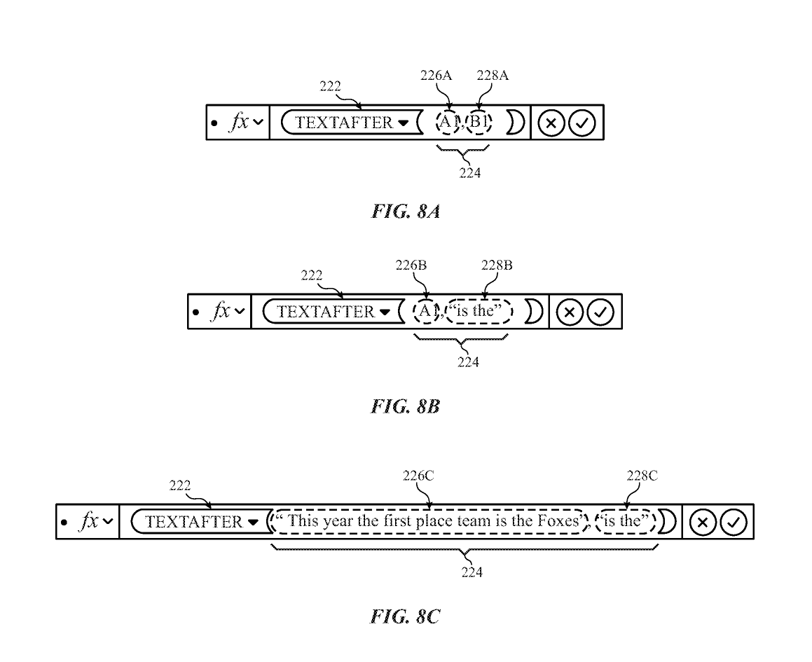

The process 120 includes retrieving the evaluation statement 220 (block 122). As will be discussed in more detail below with regard to FIGS. 8A-13B, which provide examples of evaluation statements, evaluation statements may include various functions that use one or more attribute values to carry out the function. For example, as discussed above, the attribute values may include source string attributes and/or search string attributes. The source string attributes provide an indication of a text string to search, while the search string attributes provide an indication of a text string within the source string to search for.

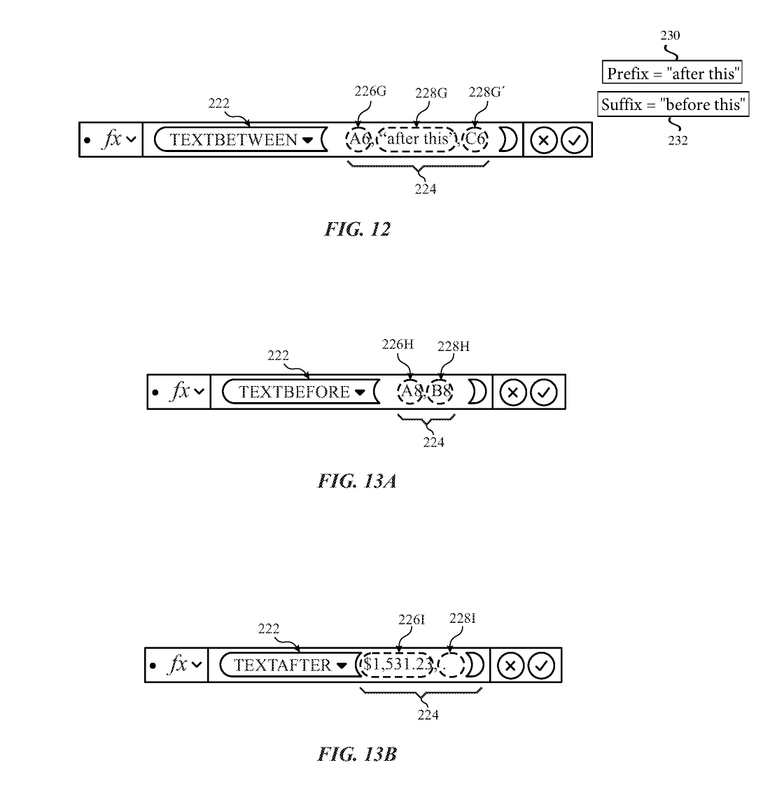

In some instances, functions (e.g., TEXTBEFORE and TEXTAFTER) may use one source string attribute and one search string attribute. FIGS. 8A-11 and 13A-13B illustrate example usage of these functions. In other instances, some functions (e.g., TEXTBETWEEN) may use one source string attribute and more than one search string attribute. FIG. 12 illustrates example usage of this function.

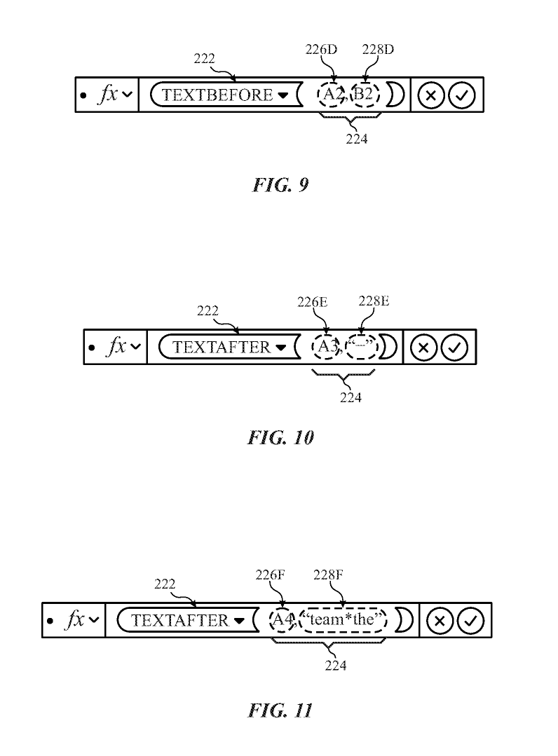

The process 120 includes retrieving the source string (block 124) from the evaluation statement. As may be appreciated, in some instances, the source string attribute may specify a cell via a cell reference. For example, FIGS. 8A, 8B, and 9-13A illustrate source string attributes that specify a particular cell to identify the source string. FIGS. 8A-8B illustrate the use of the TEXTAFTER function where the source string attributes 226A and 226B identify the contents of cell A1 as the source string. Referring back to the example table in FIG. 5, these cells identify to “This year the first place team is the Foxes”. Thus, this text is the source string for the evaluation statements of FIGS. 8A and 8B. In FIG. 9, the source string attribute 226D identifies the contents of cell A2 as the source string. Referring back to the example table in FIG. 5, the source string identified by the source string attribute 226D is, thus, “Next, the second place team is the Spurs”. Similarly, the source string attribute 226E and 226F of FIGS. 10-11 identify the contents of cells A3 and A4 as the source string, respectively. Referring to the example table in FIG. 5, the source strings identified by the source string attributes 226E and 226F are “The third place team, the Cannons” and “Finally, the fourth place team is the Red Devils”, respectively. In FIG. 13A, the source string attribute 226H identifies the contents of cell A8 as the source string. Referring back to the example table in FIG. 5, the source string identified by the source string attribute 226H is, thus, “$1,531.23”.

In other embodiments, the source string attribute may specify, as the source string, a textual value, a numerical value, or other values rather than a cell reference. An example of an evaluation statement specifying the source string attribute as a textual value is shown in FIG. 8C. In FIG. 8C, the source string attribute 226C specifies text rather than a particular cell. Accordingly, the text used as the source string is “This year the first place team is the Foxes”.

Though the examples of source string attributes 226 identified so far have included textual values only (or cells containing textual values), it may be appreciated that the attribute values 224 (i.e., the source string attribute 226 and/or the search string attribute 228) may include non-textual values. The attribute values 224 may include a numbers, symbols, other non-text characters, or a combination of such non-text characters. An example of an evaluation statement 220 specifying the source string attribute 226I as a non-textual value is shown in FIG. 13B. Here, the value used as the source string may be defined as $1531.23. In FIG. 13B, the source string attribute 226I references a non-textual value (e.g., a currency value) rather than a reference to a particular cell. As will be discussed in more detail below, the non-textual values may be converted to textual values.

Returning to FIG. 6, the process 120 includes retrieving the search string (block 126). As may be appreciated, the search string attribute may specify the search string using either a cell reference or a textual value, similar to the source string attribute discussed above. Examples of evaluation statements specifying the search string attribute as a cell reference are shown in FIGS. 8A, 9, 12, and 13A. For example, FIG. 8A illustrates the use of the TEXTAFTER function. In FIG. 8A, the search string attribute 228A identifies the contents of the cell B1 as the search string. Referring back to the example table in FIG. 5, the search string is thus identified as “is the”. The search string indicates a string within the source string, indicated by source string attribute 226A, that the particular function (here “TEXTAFTER”) should search for, as explained in further detail below. In FIGS. 9 and 13A, the search string attributes 228D and 228H identify the contents of the cells B2 and B8, respectively. Referring back to the example table in FIG. 5, the search strings are thus identified as “is the” and “.”, respectively.

Certain evaluation statements (e.g., evaluation statements that use the TEXTBETWEEN function) may use more than one search string attribute, as illustrated in FIG. 12. In FIG. 12, two search string attributes 228G and 228G′ are used by the TEXTBETWEEN search function. Search string attribute 228G may provide a prefix identifier 230 and search string attribute a suffix identifier 232. The prefix identifier 230 identifies a prefix to search for within the source string and the suffix identifier 232 provides a suffix to search for within the source string. Locations where the prefix identifier 230 and suffix identifier 232 are found within the source string 226G are used to perform the TEXTBETWEEN function, as explained in further detail below. In the illustrated embodiment, the prefix identifier 230 explicitly indicates a text string “after this”, resulting in “after this” being set as the prefix. The suffix identifier 232 identifies the contents of cell C6 as the suffix. Referring back to the example table in FIG. 5, the contents of cell C6 is “before this”, resulting in “before this” being set as the suffix.

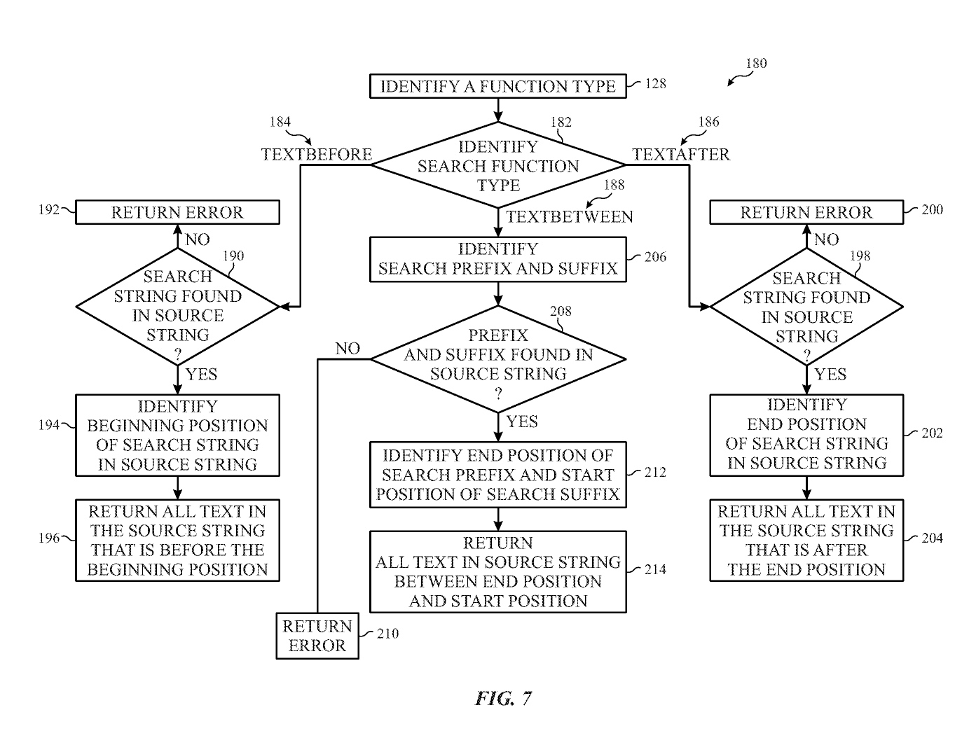

The process 120 of FIG. 6 includes identifying the function type (block 128). The function type specifies where in the source string the function returns text. The text that is returned by the function type identifies a substring by the one or more search string attribute(s). For example, the function TEXTBEFORE indicates that the function should identify a substring in the source string that is located at a location before the specified search string, as explained further with reference to FIG. 7. Other presently contemplated function types include the TEXTAFTER and TEXTBETWEEN functions. As previously discussed, these function types provide a spatial context with regard to the search string, indicating which spatial portion of the source string to return. For example, the TEXTBEFORE function will search a portion of the source string before the search string. The TEXTAFTER function will search a portion of the source string after the search string. The TEXTBETWEEN function will search a portion of the source string between a search prefix and a search suffix.

Upon completing the search, the search results are returned (block 132). For example, as will be disclosed in detail below, the portion of the source string before the search string will be returned for a TEXTBEFORE function call. The portion of the source string after the search string will be returned for the TEXTAFTER function call. The portion of the source string between the search prefix and the search suffix will be returned for the TEXTBETWEEN function call. If the search function is not found, an error indication may be returned.

FIG. 7 depicts a process flow diagram 180 depicting control logic of blocks 128-132 of the process 120 of FIG. 6. The process 180 diverges based upon the search function type decision (block 182). The function type may be identified according to the function called by the expression statement. Certain search function type possibilities discussed herein include the TEXTBEFORE function type (indicated by arrow 184), the TEXTAFTER function type (identified by arrow 186), and the TEXTBETWEEN function type (identified by arrow 188).

### TextBefore Function

When the function type is the TEXTBEFORE function, a determination is made as to whether the search string is identified in the source string (block 190). If the search string is not identified within the source string, the process 180 returns an indication of an error, such as an error message (block 192). If the search string is identified within the source string, the process 180 identifies the beginning position of the search string within the source string (e.g., the position where the first character of the search string appears) (block 194).

The TEXTBEFORE function may be further understood with reference to FIGS. 5, 9, and 13A. In the example of FIG. 9, the search string attribute 228D identifies the values in cell B2 (here “is the”) as the search string, and the source string attribute 226D identifies the values in cell A2 (here “Next, the second place team is the Spurs”) as the source string. In the example of FIG. 13A, the search string attribute 228H identifies the content in cell B8 (here “.”) as the search string. The source string attribute 226H is identified as the value in cell A8 (here “$1,531.23”).

The process 180 of FIG. 7 then returns all of the text values (or non-text values) in the source string that is before the beginning position (block 196). Continuing the discussion of the example of FIGS. 9 and 13A discussed herein, the process 180 then applies the TEXTBEFORE function to return the searched values. Here, “Next, the second place team” is displayed in cell C2 and “$1,531” is displayed in cell C8.

### TextAfter Search Function

When the function type is the TEXTAFTER function (e.g., arrow 186), a determination is made as to whether the search string is identified in the source string (decision block 198). If the search string is not identified within the source string, the process 180 returns an indication of an error, such as an error message (block 200). If the search string is identified within the source string, the process 180 identifies the end position of the search string within the source string (e.g., the position where the last character of the search string appears) (block 202).

The TEXTAFTER function may be further understood with reference to FIGS. 8A-C, 10, 11, and 13B. In FIG. 8A, the search string attribute 228A identifies the content in cell B1 (here “is the”). This search string is searched in the source string identified in cell A1 (here “This year the first place team is the Foxes”). It may be appreciated that the search string attribute 228A identified in FIGS. 8A-C identify the same search string in two different ways. In FIG. 8A, the search string attribute 228A is identified via the contents of cell B1, while in FIGS. 8B-C, the search string attributes 228B, 228C are identified via the text values “is the”. The process 180 of FIG. 7 identifies the end position of the search string “is the” within the source string (here “This year the first place team is the Foxes”). The source string attributes 226A-C identified in FIGS. 8A-C also identify the same source string in two different ways. In FIGS. 8A-B, the source string attributes 226A, 226B are identified via the contents of cell A1 to identify the source strings. In FIG. 8C, the source string attribute 226C is identified via the text value “This year the first place team is the Foxes”. Accordingly, in FIGS. 8A-C, the substring after the last character in the search string is “Foxes”.

In the example of FIG. 10, the search string is identified as “-”. In this example, the process 180 of FIG. 7 attempts to identify the end position of the search string “-” within the source string (here “This third place team, the Cannons”) identified by the source string attribute 226E. However, the search string is not present in the source string, and thus the search string cannot be found. As such, an indication of error is output in cell C3, which is the cell that contains the expression statement of FIG. 10. This is described in more detail below, with respect to the returned results portion of process 180.

In some embodiments, the search string may include a wild card, such as “*”. In the example in FIG. 11, the process 180 of FIG. 7 identifies the search string attribute 228F as “team*the”. In this example, the process 180 attempts to identify the end position of the search string “team*the” within the source string defined by source string attribute 226F (here cell A4). The process 180 of FIG. 7 locates a first portion 252 (here “team”) in the source string (see FIG. 5). The process 180 then continues to search the source string for a last portion 254 (here “the”) (see FIG. 5). The process 180 of FIG. 7 identifies any character in the source string as a “match” to the asterisk located in a middle portion of the search string.

In the example in FIG. 13B, the process 180 of FIG. 7 identifies. as the search string, which is defined by the search string attribute 228I. In this example, the process 180 of FIG. 7 identifies the source string attribute 226I as $1.531.23. The process 180 of FIG. 7 identifies the end position of the search string (here.), within the source string.

The process 180 of FIG. 7 then returns all of the text values (or non-text values) in the source string that is after the end position (block 204). Continuing the discussion of the example of FIGS. 8A-C, 10, 11, and 13B discussed herein, the process then returns the values found in the source strings. For example, in each expression statement of FIGS. 8A-8C, the TEXTAFTER function returns the value “Foxes”. An example of this result is illustrated in cell C1 of FIG. 5.

As discussed above, in the example illustrated in FIG. 10, the TEXTAFTER function returns an indication of an error when the search string (here “-”) is not found in the source string. The indication of an error can be displayed as an exclamation point or other symbol, an error message, or any other form of an error indication.

In the example illustrated in FIG. 11, the TEXTAFTER function searches the source string to find the end position of the search string and returns the value “Red Devils”. This result is illustrated in cell C4 of FIG. 5. Finally, in the example illustrated in FIG. 13B, the TEXTAFTER function returns the value “23”. This result is illustrated in cell C8 of FIG. 5.

### TextBetween Search Function

When the function type is the TEXTBETWEEN function 188, the process 180 of FIG. 7 includes identifying a search prefix and a search suffix (block 206), as discussed above with regard to FIG. 12. Using the expression statement of FIG. 12 as an example, the search prefix 230 is “after this” and the search suffix 232 is “before this”.

The search prefix 230 and the search suffix 232 may be contents of a particular cell (e.g., cell C6 as illustrated in FIG. 12), text values (“after this” as illustrated in FIG. 12), and/or non-text values. The end of the search prefix 230 identifies a beginning location for a substring that the TEXTBETWEEN function 188 should return. Returning to the example of FIG. 12, the last character of the search prefix 230 “after this” marks the starting point for the subset string to return from the TEXTBETWEEN function, as illustrated by arrow 240 in FIG. 5.

The start of the search suffix 232 identifies an end location for the substring that the TEXTBETWEEN function 188 should return. Returning to the example of FIG. 12, the first character of the search suffix 232 “before this” marks the ending point for the subset string to return from the TEXTBETWEEN function, as illustrated by arrow 242 in FIG. 5. Together, the search prefix 230 and the search suffix 232 identify a portion in the source string that the TEXTBETWEEN function should return.

To capture the proper subset of text flanked by the search prefix and search suffix, the process 180 of FIG. 7 includes determining whether the search prefix 230 and the search suffix 232 are identified in the source string (block 208). If the search prefix 230 and/or the search suffix 232 are not identified in the source string, the process 180 returns an indication of an error, such as an error message (block 210). If both the search prefix 230 and the search suffix 232 are identified within the source string, the process 180 identifies the beginning location (e.g., the end position of the search prefix 230) and the end location (e.g., the start position of the search suffix 232) within the source string (block 212) which the TEXTBETWEEN function should return. The process 180 includes returning the portion between the beginning location 240 and the end location 242 within the source string (block 214).

The TEXTBETWEEN function 188 may be further understood by returning to the example of FIG. 12 with reference to FIG. 5. In the example of FIG. 12, the process 180 of FIG. 7 identifies the search prefix 230 as text string “after this” and identifies the search suffix as the contents of cell C6 (here text string “before this”). The source string is identified as the contents of cell A6. Returning to FIG. 5, the contents of cell A6 include the phrase “123 before this 456 after this 789 before this”.

It may be noted in the present example that the search suffix 232 is found twice in the source string. However, the TEXTBETWEEN function 188 requires identification of both the search prefix 230 and the search suffix 232 to determine the beginning location 240 and the end location 242 for the TEXTBETWEEN function 188 to be executed. Accordingly, the TEXTBETWEEN function 188 identifies the search prefix 230 (here “after this”) and the search suffix (here “before this”) in the source string. Despite multiple occurrences of “before this” in the source string, only one occurrence is after the search prefix 230, thus this occurrence will be identified as the proper suffix. The resulting value “789” is then output in the cell D6, as illustrated in FIG. 5. Had there not been an occurrence of the search suffix 232 after the search prefix 230, the TEXTBETWEEN function would return an error.

In embodiments where multiple occurrences of the suffix occur after the prefix, the TEXTBETWEEN function 188 may implement a more conservative approach, identifying the first occurrence as the proper suffix. Alternatively, the TEXTBETWEEN function 188 may implement a more liberal approach, identifying the last occurrence as the proper suffix.

### Conversion to String Values

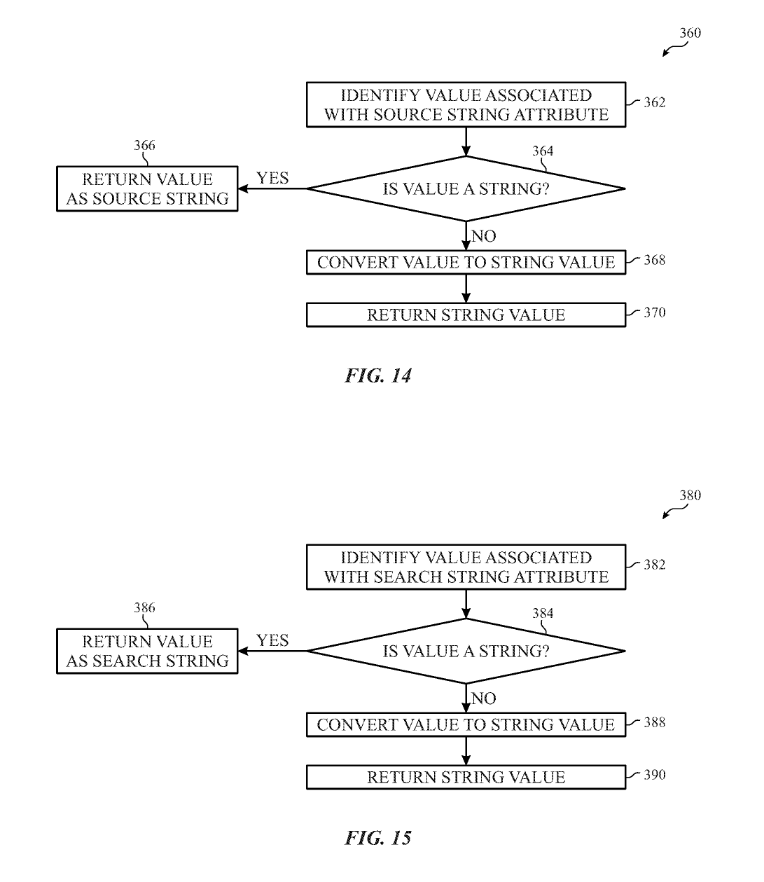

Until now, the discussion of the present techniques has primarily pertained to using string values as the source strings and/or the search strings. When either the search string or the source string includes a value that is not a recognized string value, the functions 222 may convert the value to a string value to facilitate string searching using the functions 222 called in the spreadsheet application, as explained further with reference to FIGS. 14-15. That is, by converting the values that are not string values to string values before executing the operation associated with the function 222, the function 222 may result in fewer outputs indicating an error (e.g., caused when only string data is handled). FIG. 14 depicts a process 360 for converting a value of the source string to a string value in accordance with aspects of the present disclosure.

The process 360 includes identifying a value associated with the source string attribute 226 (block 362). The identified value may reference a particular cell (e.g., cell A2, etc.) or identify an actual text (or non-text) string, such as “This year the first place team is the Foxes” or $1,531.23 (a currency value).

The process 360 determines whether the value associated with the source string attribute 226 is a string of text or a non-string (e.g., currency, date, time, etc.) (block 364). If the process 360 determines that the value associated with the source string attribute 226 is a string of text (i.e., textual characters, including numerical characters, symbols, etc.), the process 360 uses the value as the source string for the function 222 (block 366). For example, for the expression statements of FIGS. 8A, 8B, and 8C, the process 360 would return the text “This year the first place team is the Foxes” as the identified value for the source string.

If the process 360 determines that the value associated with the source string attribute 226 is not a string, the process 360 converts the identified value to a string value (block 368). Non-text values may be converted to text values by taking the string representation of the non-text values as a value of the non-text string. For example, currency, such as $1.50 may be converted to “$1.50”. Further, a date Jan. 1, 2018 may be converted to “01/01/2018”. That is, in the present example, when the identified value references a currency (e.g., cell A8 of FIG. 5), the process 360 converts the cell's non-string value to a string value.

The process 360 then returns the string value (block 370). Here, the returned string value is “$1,531.23”. As may be appreciated, conversion of identified values of search string attributes works in a similar manner, as explained with reference to FIG. 15.

FIG. 15 illustrates a process 380 for converting a value of a search string to a string value in accordance with aspects of the present disclosure. The process 380 includes identifying a value associated with the search string attribute 228 (block 382). The identified value may be a reference to the search string, such as a cell reference (e.g., cell A3, etc.) or the identified value may be an actual text string, such as “is the” or a non-text string, such as currency, date, etc.

The process 380 determines whether the value associated with the search string attribute 228 is a string or a non-string (e.g., currency, date, time, etc.) (block 384). If the process 380 determines that the value associated with the search string attribute 228 is a string (i.e., textual characters, numerical characters, symbols, etc.), the process 380 returns the value as the search string that the function 222 uses to search within the source string when the function 222 is called (block 386). In the present example, the process 380 would return as the search string 228 the text “is the” when the identified value is a string.

If the process 380 determines that the value associated with the search string attribute 228 is not a string, the process 380 converts the identified value to a string value (block 388).

Using the expression statement of FIG. 13B as an example, when the identified value references a currency (e.g., $1,531.23), the process 380 converts the cell's value to a string value (e.g., “$1,531.23”). The process 360 then returns the string value (block 390).

It may be appreciated that in some embodiments the cell type of the source string may be tracked and the resultant value of an evaluation statement may be converted back to the former cell type. For example, the expression statement of FIG. 13B uses a source string 226I with a currency type. After a text string result of the function 222 is obtained, the text string result may be converted back to the original format of the source string 226I (e.g., currency). To do this, the context may be derived from the search string 2281 and/or the type of function 222 that is used. For example, in FIG. 13B, the TEXTAFTER function is used and the search string is a decimal point. Further, the source string 226I is currency. This clearly provides context for the results being cents. Accordingly, the resultant text string of “23” can be converted back to a non-string value (e.g., $0.23).

However, had the TEXTBEFORE function been used, this would clearly indicate the results being dollars. Such an expression statement would have resulted in a text string of “$1,531”, which could be converted back to a currency value of $1,531. In this case, identifying the context may not be needed, as a currency symbol is already provided in the resultant text string.

### Maintaining Dependencies

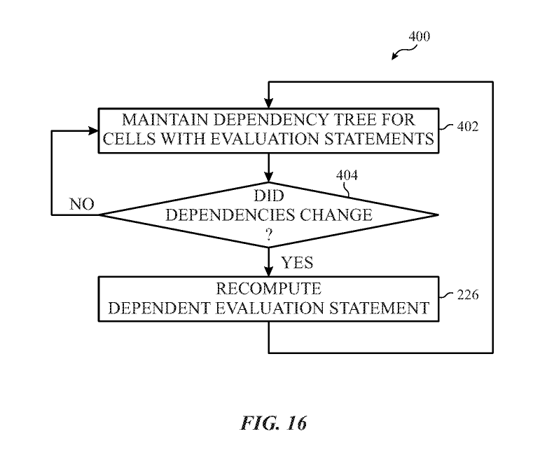

Until now, the discussion in this section has pertained to converting the non-string values to string values so that non-string values may be handled when the functions 222 are called. When the cell's values in the functions 222 are changed, it may be appreciated that function 222 may be recomputed to output correct values, as explained further with reference to FIG. 16.

FIG. 16 illustrates a process 400 for maintaining a dependency tree of the evaluation statements 220 in accordance with aspects of the present disclosure. The process 400 includes maintaining a dependency tree for cells that contain functions 222 or evaluation statements that include references to cells (e.g., dependencies) (block 402). That is, when a cell containing a function 222 includes one or more attributes (e.g., a source string attribute 226, a search string attribute 228) that specify cells, the process 400 will track these cells (e.g., dependencies) for the function 222 so that a change to the specified cells will trigger the function 222 to be re-processed.

The process 400 includes determining whether the dependencies have changed (block 404). When the process 400 determines that no changes have occurred in the dependent attributes (e.g., the specified cells in the source string attribute 226 and/or the search string attribute 228), the process continues to monitor the dependency tree for changes.

When the process 400 determines that a change has occurred in the dependent attributes (e.g., the specified cells in the source string and/or the search string), the process 400 then recomputes the function (i.e., evaluation statement) using the newest value of the changed dependent attribute (block 406).

For example, if the “is the” text of cell B1 of FIG. 5 changes to “first place”, the output from the function call would recompute the function 222 of FIG. 8A, which has a dependency on cells A1 and B1 of FIG. 5. In the present example, the function 222 of FIG. 8A, which outputs a value to cell C1 of FIG. 5, would be recomputed to output the result “team is the Foxes” instead of “Foxes”. Similarly, if cell A1 (e.g., the cell referenced in the source string attribute 226A of FIG. 8A) is updated, the function call would recompute the function 222 to update the value that is output to a cell (i.e., cell C1.) As may appreciated, the process 400 recomputes the function when the source string, the search string, or both change.

The specific embodiments described above have been shown by of example, and it should be understood that these embodiments may be susceptible to various modifications and alternative forms. It should be further understood that the claims are not intended to be limited to the particular forms disclosed, but rather to cover all modifications, equivalents, and alternatives falling within the spirt and scope of this disclosure. For example, while the discussion herein described a function with a first search attribute and a second modal attribute, any number and type of attributes may be processed using the techniques provided herein.

What is claimed is:

1. A tangible, non-transitory, machine-readable medium, comprising machine-readable instructions that, when executed by one or more processors, cause the one or more processors to:
receive, via a graphical user interface (GUI) of a spreadsheet application, a function call, the function call comprising:
a source string attribute, the source string attribute identifying a string;
a search string attribute, the search string attribute identifying a substring to be identified in the string;
perform a function associated with the function call, by:
searching for the substring in the string; and
returning a subset of the string proximate to a location of the substring in the string.

2. The machine-readable medium of claim 1, wherein:
the function comprises a function to return text before the substring; and
the subset of the string that is returned comprises a portion of the string that is located before the substring in the string.

3. The machine-readable medium of claim 1, wherein:
the function comprises a function to return text after the substring; and
the subset of the string that is returned comprises a portion of the string that is located after the substring in the string.

4. The machine-readable medium of claim 1, wherein:
the function comprises a second search string attribute, the second search string attribute identifying a second substring to be identified in the string;
the function comprises a function to return text between the substring and the second substring; and
the subset of the string that is returned comprises a portion of the string that is located between the substring and the second substring in the string.

5. The machine-readable medium of claim 1, wherein the source string attribute comprises a cell reference to a cell containing the string.

6. The machine-readable medium of claim 1, wherein the source string attribute comprises the string.

7. The machine-readable medium of claim 1, wherein the search string attribute comprises a cell reference to a cell containing the substring.

8. The machine-readable medium of claim 1, wherein the search string attribute comprises the substring.

9. The machine-readable medium of claim 1, comprising machine-readable instructions that, when executed by the one or more processors, cause the one or more processors to perform the function, by:
determining if a value identified with the source string attribute is a string value; and
converting the value to a string value when the source string attribute is not a string value.

10. The machine-readable medium of claim 9, wherein determining the value comprises a currency, a date, a time, a number, or any combination thereof, and setting a textual representation of the value as the string value.

11. The machine-readable medium of claim 1, comprising machine-readable instructions that, when executed by the one or more processors, cause the one or more processors to:
maintain a dependency tree identifying dependent cells for a cell in the GUI containing the function call, the dependent cells comprising cells referenced by the source string attribute, the search string attribute, or both; and
perform the function, by:
determining if the dependent cells have changed; and
recomputing a result of the function call when the dependent cells have changed.

12. The machine-readable medium of claim 1, comprising machine-readable instructions that, when executed by the one or more processors, cause the one or more processors to output an error indication when the substring is not identified in the string.

13. A processor-implemented method for receiving a function call, comprising:
receiving, via a graphical user interface (GUI) of a spreadsheet application, the function call, the function call comprising:
a source string attribute, the source string attribute identifying a string;
a search string attribute, the search string attribute identifying a substring to be identified in the string;
performing a function associated with the function call, by:
searching for the substring in the string; and
returning a subset of the string proximate to a location of the substring in the string.

14. The processor-implemented method of claim 13, wherein:
the function comprises a function to return text before the substring; and
the subset of the string that is returned comprises a portion of the string that is located before the substring in the string.

15. The processor-implemented method of claim 13, wherein:
the function comprises a function to return text after the substring; and
the subset of the string that is returned comprises a portion of the string that is located after the substring in the string.

16. The processor-implemented method of claim 13, wherein:
the function comprises a second search string attribute, the second search string attribute identifying a second substring to be identified in the string;
the function comprises a function to return text between the substring and the second substring; and
the subset of the string that is returned comprises a portion of the string that is located between the substring and the second substring in the string.

17. An electronic device, comprising:
a display configured to display content; and
at least one processor communicatively coupled to the display, wherein the at least one processor comprises instructions to:
receive, via a graphical user interface (GUI) of a spreadsheet application, a function call, the function call comprising:
a source string attribute, the source string attribute identifying a string;
a search string attribute, the search string attribute identifying a substring to be identified in the string;
perform a function associated with the function call, by:
searching for the substring in the string; and
returning a subset of the string proximate to a location of the substring in the string.

18. The electronic device of claim 17, wherein:
the function comprises a function to return text before the substring; and
the subset of the string that is returned comprises a portion of the string that is located before the substring in the string.

19. The electronic device of claim 17, wherein:
the function comprises a function to return text after the substring; and
the subset of the string that is returned comprises a portion of the string that is located after the substring in the string.

20. The electronic device of claim 17, wherein:
the function comprises a second search string attribute, the second search string attribute identifying a second substring to be identified in the string;
the function comprises a function to return text between the substring and the second substring; and
the subset of the string that is returned comprises a portion of the string that is located between the substring and the second substring in the string.
